(19) United States
(12) Patent Application Publication
(10) Pub. No.: US 2026/0008213 A1
(43) Pub. Date: Jan. 8, 2026

(54) CHAOTIC SINGLE-SCREW EXTRUSION INJECTION DEVICE

(71) Applicant: WUYI UNIVERSITY, Jiangmen (CN)

(72) Inventors: Baiping XU, Jiangmen (CN); Kang QIU, Jiangmen (CN); Huiwen YU, Jiangmen (CN); Shuping XIAO, Jiangmen (CN); Lingcao TAN, Jiangmen (CN); Jiarong HUANG, Jiangmen (CN); Wenhua XU, Jiangmen (CN)

(21) Appl. No.: 18/994,408

(22) PCT Filed: Aug. 3, 2022
(86) PCT No.: PCT/CN2022/110036

§ 371 Date: Jan. 14, 2025

(30) Foreign Application Priority Data
Jul. 25, 2022 (CN) 202210879831.5

(51) Int. Cl. B29C 45/47

(52) U.S. Cl. CPC B29C 45/47

(57) ABSTRACT

A chaotic single-screw extrusion injection device includes: a barrel; and a screw, arranged in the barrel. An outer surface of the screw is provided with a flight, a first disturbing member, and a second disturbing member; the flight extends spirally along an axial direction of the screw. One end of the first disturbing member is connected to a thrust surface of the flight, and another end of the first disturbing member extends towards a dragging surface of the flight. One end of the second disturbing member is connected to the dragging surface of the flight, and another end of the second disturbing member extends towards the thrust surface of the flight

### CROSS-REFERENCE TO RELATED APPLICATIONS

This application is a national stage filing under 35 U.S.C. § 371 of international application No. PCT/CN2022/110036, filed Aug. 3, 2022, which claims priority to Chinese patent application No. 2022108798315 filed Jul. 25, 2022. The contents of these applications are incorporated herein by reference in their entirety.

### TECHNICAL FIELD

Embodiments of the present disclosure relate to, but not limited to, the field of extrusion injection devices, and in particular, to a chaotic single-screw extrusion injection device.

### BACKGROUND

Single-screw mechanism has advantages of a simple structure, easy operation and maintenance, and a capability to build stable extrusion pressure, which is widely used in extrusion molding and injection molding processes. The single-screw mechanism is mainly based on a friction drag principle. From a normal section of a flight, a structure of a screw groove is symmetrical after unfolding, which can be simplified into a physical model of dragging of a square groove with an upper cover. Solid conveying, melting, mixing, and extrusion pressure building are all completed in such a physical model. The conveying principle lies mainly in friction drag conveying. Due to the symmetry of flow channel, the efficiency of controlling melt plasticization and mixing in the extrusion process is unsatisfactory, and the processing consumes huge energy. To improve the melt plasticization efficiency and enhance the mixing effect, at present, the engineering industry generally adopts screws such as barrier flight screws, barrier screws, and pin screws, and the like, which mainly enhance heat transfer by separating a solid bed from a melt pool, and enhance mixing by cutting and diverting fluid. However, enhancement elements are limited in size, which do not have significant effects, and the enhancement principle is still limited to classic laminar mixing. These enhancement measures generally have defects such as weak processing elasticity, easily blocking of the screw groove by solid materials, and easy accumulation of materials in dead areas of the flow channel.

### SUMMARY

The following is a summary of the subject matter described in detail herein. This summary is not intended to limit the protection scope of the claims.

Embodiments of the present disclosure provide a chaotic single-screw extrusion injection device, capable of generating a longitudinal extrusion and extensional flow, which in combination with a cross-sectional circulation effect of a screw groove, induces a chaotic mixing enhancement effect.

The following technical schemes are used in the embodiments of the present disclosure to resolve the technical problems.

A chaotic single-screw extrusion injection device includes:

a barrel; and

a screw, arranged in the barrel, where an outer surface of the screw is provided with a flight, a first disturbing member, and a second disturbing member; the flight extends spirally along an axial direction of the screw; one end of the first disturbing member is connected to a thrust surface of the flight, and another end of the first disturbing member extends towards a dragging surface of the flight; and one end of the second disturbing member is connected to the dragging surface of the flight, and another end of the second disturbing member extends towards the thrust surface of the flight.

Further, the first disturbing member and the second disturbing member are curved conical structures.

Further, the first disturbing member and the second disturbing member form a clearance between the flight and an inner wall of the barrel to generate extrusion and extension effects.

Further, a screw groove is formed between two adjacent flights.

Further, a baffle is arranged in the screw groove, and the baffle forms an extension direction of a spiral line.

Further, a centerline eccentric distance of the first disturbing member is less than or equal to a depth of the screw groove, and a centerline eccentric distance of the second disturbing member is less than or equal to the depth of the screw groove.

Further, a height of the first disturbing member satisfies the following formula: h1=aH, where h1 is the height of the first disturbing member; a height of the second disturbing member satisfies the following formula: h2=aH, where h2 is the height of the second disturbing member; and H is the depth of the screw groove, a is a weight parameter, and a value range of a is 0.01 to 1.

Further, a range of a central angle corresponding to the first disturbing member is π/10≤α1≤2π, where α1 is the central angle corresponding to the first disturbing member; and a range of a central angle corresponding to the second disturbing member is π/10≤α2≤2π, where α2 is the central angle corresponding to the second disturbing member.

Further, a height of the baffle is less than or equal to the depth of the screw groove.

Further, a centerline of the baffle is eccentrically arranged with respect to an axis of the screw, and an eccentric distance of the baffle is less than or equal to the depth of the screw groove.

The chaotic single-screw extrusion injection device has at least the following beneficial effects. In an injection molding process, the screw generates an axial forward/backward effect, such that the chaotic single-screw extrusion injection device can generate a longitudinal extrusion and extensional flow, which in combination with a transverse circulation effect in a cross section of the screw groove, induces a chaotic mixing enhancement effect, thereby effectively improving efficiency of melt plasticization and mixing of materials while ensuring a smooth flow channel. The first disturbing member and the second disturbing member generate a wedge-shaped pressurization enhancement effect in an axial section of the screw, forming a melting and mixing enhancement mechanism, which more effectively improves melt plasticization efficiency of the screw.

### BRIEF DESCRIPTION OF DRAWINGS

The accompanying drawings are used to provide a further understanding of the technical schemes of the present disclosure, which constitute a part of the present disclosure, and are used together with the embodiments of the present disclosure to illustrate the technical schemes of the present disclosure, but do not constitute a limitation on the technical schemes of the present disclosure.

FIG. 1 is a structural diagram of a chaotic single-screw extrusion injection device according to an embodiment of the present disclosure;

FIG. 2 is a structural diagram of a screw according to an embodiment of the present disclosure;

FIG. 3 is a structural diagram of geometric configurations of a first disturbing member and a second disturbing member in a cross section of the screw; and

FIG. 4 is a structural diagram of a geometric configuration of a baffle in a cross section of the screw.

### DETAILED DESCRIPTION

To make the objectives, technical schemes, and advantages of the present disclosure clear and comprehensible, the present disclosure is further described below in detail in conjunction with the accompanying drawings and embodiments. It is to be understood that the specific embodiments described herein are merely used to illustrate the present disclosure and are not intended to limit the present disclosure.

It is to be noted, although functional modules have been divided in the schematic diagrams of devices and logical orders have been shown in the flowcharts, in some cases, the modules may be divided in a different manner, or the steps shown or described may be executed in an order different from the orders as shown in the flowcharts. The terms such as “first”, “second” and the like in the description, the claims, and the accompanying drawings are used to distinguish similar objects, and are not necessarily used to describe a specific sequence or a precedence order.

Embodiments of the present disclosure provide a chaotic single-screw extrusion injection device, including a barrel and a screw. The screw is arranged in the barrel, and an outer surface of the screw is provided with a flight, a first disturbing member, and a second disturbing member. The flight extends spirally along an axial direction of the screw. One end of the first disturbing member is connected to a thrust surface of the flight, and another end of the first disturbing member extends towards a dragging surface of the flight. One end of the second disturbing member is connected to the dragging surface of the flight, and another end of the second disturbing member extends towards the thrust surface of the flight. In this way, a longitudinal flow can be generated, which in combination with a transverse circulation effect in a cross section of a screw groove, induces a chaotic mixing enhancement effect, thereby effectively improving efficiency of melt plasticization and mixing of materials while ensuring a smooth flow channel. In an injection molding process, the screw generates an axial forward/backward effect, and the first disturbing member and the second disturbing member generate a wedge-shaped pressurization enhancement effect in an axial cross section of the screw, forming a melting and mixing enhancement mechanism, which more effectively improves melt plasticization efficiency of the screw.

The embodiments of the present disclosure are further described below in conjunction with the accompanying drawings.

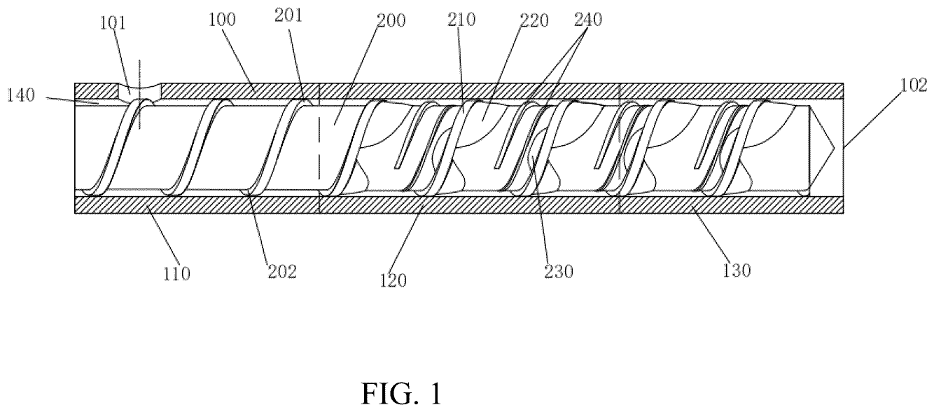

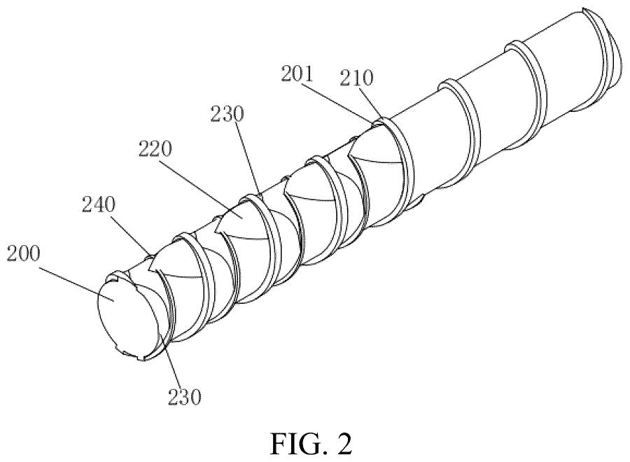

With reference to FIG. 1 and FIG. 2, an embodiment of the present disclosure provides a chaotic single-screw extrusion injection device. The chaotic single-screw extrusion injection device includes a barrel 100 and a screw 200.

The screw 200 is arranged in the barrel 100, and an outer surface of the screw 200 is provided with a flight 210, a first disturbing member 220, and a second disturbing member 230. The flight 210 extends spirally along an axial direction of the screw 200. One end of the first disturbing member 220 is connected to a thrust surface 201 of the flight 210, and another end of the first disturbing member 220 extends towards a dragging surface 202 of the flight 210. One end of the second disturbing member 230 is connected to the dragging surface 202 of the flight 210, and another end of the second disturbing member 230 extends towards the thrust surface 201 of the flight 210.

The dragging surface 202 and the thrust surface 201 are respectively formed on left and right side walls of the flight 210 according to a force situation of conveyed materials.

A material conveying channel 140 is formed between the outer surface of the screw 200 and an inner surface of the barrel 100.

A feed port 101 is arranged on an upper side of one end of the barrel 100, and a discharge port 102 is arranged on another end of the barrel 100. The barrel 100 is sequentially provided with a conveying section 110, a melting section 120, and a metering section 130 in a direction from the feed port 101 to the discharge port 102. The metering section 130 includes a mixing section and a homogenizing section.

In this embodiment, in an injection molding process, the screw 200 generates an axial forward/backward effect, such that the chaotic single-screw extrusion injection device can generate a longitudinal flow, which in combination with a transverse circulation effect in a cross section of a screw groove, induces a chaotic mixing enhancement effect, thereby effectively improving efficiency of melt plasticization and mixing of materials while ensuring a smooth flow channel. The first disturbing member 220 and the second disturbing member 230 generate a wedge-shaped pressurization enhancement effect in an axial section of the screw 200, forming a melting and mixing enhancement mechanism, which more effectively improves melt plasticization efficiency of the screw 200.

In some embodiments, an outermost side of the flight 210 tangentially fits the inner surface of the barrel 100.

In some embodiments, the first disturbing member 220 and the second disturbing member 230 are curved conical structures. In this way, the chaotic single-screw extrusion injection device can generate a longitudinal zigzag flow, which in combination with the transverse circulation effect in the cross section of the screw groove, induces a chaotic mixing enhancement effect.

In some embodiments, the first disturbing member 220 and the second disturbing member 230 form a clearance between the flight 210 and an inner wall of the barrel 100 to generate extrusion and extension effects. When materials pass, the clearance generates local extrusion and extension effects on the materials.

In some embodiments, a screw groove is formed between two adjacent flights 210.

In some embodiments, the first disturbing member 220 and the second disturbing member 230 are periodically arranged starting from a compression section of the screw 200.

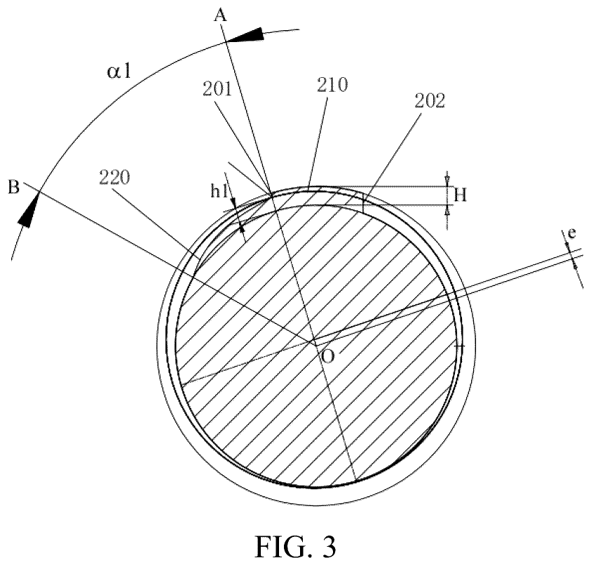

With reference to FIG. 3, in some embodiments, a centerline eccentric distance of the first disturbing member 220 is less than or equal to a depth of the screw groove, and a centerline eccentric distance of the second disturbing member 230 is less than or equal to the depth of the screw groove. To be specific, the centerline eccentric distance of the first disturbing member 220 is e1, which ranges from 0 to H; and the centerline eccentric distance of the second disturbing member 230 is e2, which ranges from 0 to H.

In some embodiments, a height of the first disturbing member 220 satisfies the following formula: h1=aH, where h1 is the height of the first disturbing member 220; a height of the second disturbing member 230 satisfies the following formula: h2=aH, where h2 is the height of the second disturbing member 230; and H is the depth of the screw groove, a is a weight parameter, which ranges from 0.01 to 1.

In some embodiments, a range of a central angle corresponding to the first disturbing member 220 is π/10≤α1≤2π, where α1 is the central angle corresponding to the first disturbing member 220; and a range of a central angle corresponding to the second disturbing member 230 is π/10≤α2≤2π, where α2 is the central angle corresponding to the second disturbing member 230.

For example, it can be understood that for the first disturbing member and the second disturbing member of curved conical structures, one vertex of a bottom edge of a cone is connected to a center of the screw 200 to form one edge, the other vertex of the bottom edge of the cone is connected to the center of the screw 200 to form another edge, and the two edges form a central angle. ∠AOB is the central angle α1 corresponding to the first disturbing member 220.

In some embodiments, the first disturbing member 220 and the second disturbing member 230 both adopt a multi-leaf structure, and when the number of leaves is N, a phase difference between the disturbing members of the multi-leaf structures is less than or equal to 2·/N.

A lead of the first disturbing member 220 and a lead of the second disturbing member 230 may be the same as or different from a lead of the flight 210.

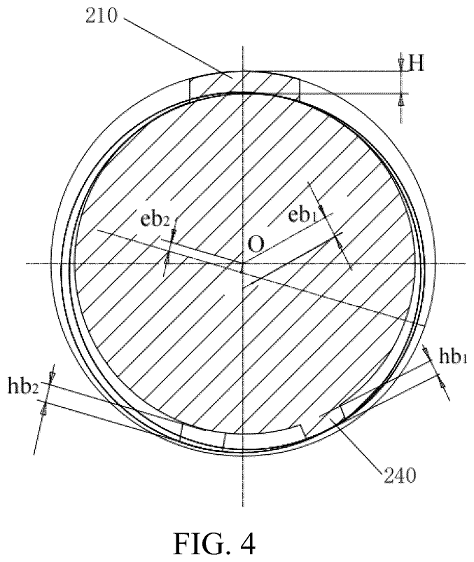

With reference to FIG. 4, in some embodiments, a baffle 240 is arranged in the screw groove, and the baffle 240 forms an extension direction of a spiral line.

In some embodiments, the baffle 240 is a protruding structure in a cross section of the screw 200. Preferably, the protruding structure is a structure in a shape of a rectangle or similar to a rectangle.

In some embodiments, the baffle 240 may have one or more leaves, and a multi-leaf baffle 240 is arranged in a peak-valley staggered mode to maximize a disturbance effect and enhance melting and mixing effects.

In some embodiments, the baffle 240 is periodically arranged starting from the compression section of the screw 200.

In some embodiments, a height of the baffle 240 is less than or equal to the depth of the screw groove.

If a height of an i^{th} baffle 240 is hbᵢ, a value range of hbᵢ is 0 to H. For example, a height hb₁ of a first baffle 240 and a height hb₂ of a second baffle 240 both satisfy the value range of 0 to H.

In some embodiments, a centerline of the baffle 240 is eccentrically arranged with respect to an axis of the screw 200, and an eccentric distance of the baffle 240 is less than or equal to the depth of the screw groove.

If there are a plurality of baffles 240, and an eccentric distance of an i^{th} baffle 240 is ebᵢ, a value range of ebᵢ is 0 to H. For example, an eccentric distance eb₁ of a first baffle 240 and an eccentric distance eb₂ of a second baffle 240 both satisfy the value range of 0 to H.

A lead of the baffle 240 may be the same as or different from the lead of the flight 210. For example, the lead of the baffle 240 is Lb, and the lead of the baffle 240 is equal to the lead of the flight 210, that is, Lb=L. For another example, a lead of a first leaf of the baffle 240 is Lb1=0.8 L, and a lead of a second leaf of the baffle 240 is Lb2=1.2 L.

The structure of the baffle 240 and the flight 210 of the screw 200 extend in the screw groove at a specific spiral angle with a streamlined structure and a periodically changing height. The multi-leaf baffle 240 is arranged in a peak-valley staggered manner to achieve cutting and diversion of fluid. In addition, a homoclinic orbit disturbance mode is introduced in the screw groove to trigger chaotic mixing, which provides another chaotic mixing mechanism for the fluid in the screw groove, and further improves melting and mixing efficiency.

In this embodiment, the streamlined first disturbing member 220 and second disturbing member 230 and the streamlined baffle 240 without sudden changes are arranged eccentrically with respect to the axis of the main screw 200 and formed through spiral sweeping, to introduce an asymmetric effect of the eccentricity, which can effectively reduce a stagnation effect of fluid and improve a self-cleaning capability of the screw groove.

Some embodiments of the present disclosure provide a plasticizing extrusion method, applied to the foregoing chaotic single-screw extrusion injection device.

Materials enter the barrel 100 from the feed port 101, and the screw 200 rotates around its own axis. Under the action of friction, the materials move along the screw groove in a material flow channel toward the discharge port 102 while being continuously compacted, pass through the conveying section 110, and enter the melting section 120.

The materials entering the melting section 120 continuously move forward along the screw groove due to the rotation of the screw 200, and are further compacted to form a solid bed, and partially molten under the action of external heating and frictional heat generation. The solid bed formed by the materials is continuously pushed forward along a longitudinal direction of the screw groove, and the melting process is accelerated by synergy between the first disturbing member 220, the second disturbing member 230, and the baffle 240. Specifically, the materials moving forward are extruded and diverted by the first disturbing member 220 and the second disturbing member 230, which induces chaotic mixing. At the same time, a wedge-shaped pressurization effect is generated along the axial direction of the screw 200, which accelerates migration of a melt film and effectively improves melting efficiency. In addition, the height of the baffle 240 periodically changes, and the multi-leaf baffle 240 is arranged in a peak-valley staggered manner, which achieves cutting and diversion of the fluid. At the same time, the homoclinic orbital disturbance mode is introduced in the screw groove to trigger chaotic mixing, which provides another chaotic mixing mechanism for the fluid in the screw groove, provides a dispersed melting principle, and further improves melting efficiency. The molten materials continue to be conveyed forward under the action of friction and enter the metering section 130.

The molten materials entering the metering section 130 continue to move forward under the action of friction. The first disturbing member 220, the second disturbing member 230, and the baffle 240 act on the melt. The curved conical disturbing structures generate local extrusion and extension effects, and a longitudinal zigzag flow is generated, which in combination with the transverse circulation effect in the cross section of the screw groove, induces a chaotic mixing enhancement effect, thereby effectively improving efficiency of mixing materials while ensuring a smooth flow channel. In addition, due to existence of the conical disturbing structures, in an injection molding process, when the screw 200 generates an axial forward/backward effect, wedge-shaped pressurization enhancement and flow extension effects are generated in the axial section of the screw 200, forming another melting and mixing enhancement mechanism, which more effectively improves mixing efficiency of the screw 200. Further, melting and plasticization processes of the materials are completed, and the molten and plasticized melt is continuously conveyed to a cavity formed between the screw 200 and the barrel 100 as the screw 200 moves backward.

After reaching a limit position of backward movement, the screw 200 moves forward along the axis of the barrel 100 under the action of an external axial thrust, and pushes the plasticized melt in front of the screw 200 to be ejected from the discharge port 102, thereby achieving injection and completing a cycle of plasticizing injection. Plasticizing injection is a cyclic process. After the injection action is completed, the foregoing process may be repeated.

1. A chaotic single-screw extrusion injection device, comprising:
a barrel; and
a screw, arranged in the barrel, wherein an outer surface of the screw is provided with a flight, a first disturbing member, and a second disturbing member; the flight extends spirally along an axial direction of the screw; one end of the first disturbing member is connected to a thrust surface of the flight, and another end of the first disturbing member extends towards a dragging surface of the flight; and one end of the second disturbing member is connected to the dragging surface of the flight, and another end of the second disturbing member extends towards the thrust surface of the flight.

2. The chaotic single-screw extrusion injection device of claim 1, wherein the first disturbing member and the second disturbing member are curved conical structures.

3. The chaotic single-screw extrusion injection device of claim 1, wherein the first disturbing member and the second disturbing member form a clearance between the flight and an inner wall of the barrel to generate extrusion and extension effects.

4. The chaotic single-screw extrusion injection device of claim 1, wherein a screw groove is formed between two adjacent flights.

5. The chaotic single-screw extrusion injection device of claim 4, wherein a baffle is arranged in the screw groove, and the baffle forms an extension direction of a spiral line.

6. The chaotic single-screw extrusion injection device of claim 4, wherein a centerline eccentric distance of the first disturbing member is less than or equal to a depth of the screw groove, and a centerline eccentric distance of the second disturbing member is less than or equal to the depth of the screw groove.

7. The chaotic single-screw extrusion injection device of claim 4, wherein a height of the first disturbing member satisfies the following formula: h1=aH, wherein hl is the height of the first disturbing member; a height of the second disturbing member satisfies the following formula: h2-aH, wherein h2 is the height of the second disturbing member; and H is the depth of the screw groove, and a is a weight parameter.

8. The chaotic single-screw extrusion injection device of claim 1, wherein a range of a central angle corresponding to the first disturbing member is π/10≤α1≤2π, wherein α1 is the central angle corresponding to the first disturbing member; and a range of a central angle corresponding to the second disturbing member is π/10≤α2≤2π, wherein α2 is the central angle corresponding to the second disturbing member.

9. The chaotic single-screw extrusion injection device of claim 5, wherein a height of the baffle is less than or equal to the depth of the screw groove.

10. The chaotic single-screw extrusion injection device of claim 5, wherein a centerline of the baffle is eccentrically arranged with respect to an axis of the screw, and an eccentric distance of the baffle is less than or equal to the depth of the screw groove.
